(19) United States
(12) Patent Application Publication
(10) Pub. No.: US 2026/0286771 A1
(43) Pub. Date: Sep. 24, 2026

(54) CORDLESS ROUND-TUBE ROLLER SHADE AND PRODUCTION PROCESS THEREOF

(71) Applicant: SHANGHAI KENDA INDUSTRIAL CO., LTD, Shanghai (CN)

(72) Inventor: Hengcai CHEN, Shanghai (CN)

(73) Assignee: SHANGHAI KENDA INDUSTRIAL CO., LTD, Shanghai (CN)

(21) Appl. No.: 19/480,045

(22) PCT Filed: Dec. 27, 2024
(86) PCT No.: PCT/CN2024/143101

§ 371 Date: Oct. 30, 2025

(30) Foreign Application Priority Data
Mar. 29, 2024 (CN) 202410373327.7

(51) Int. Cl. E06B 9/44

(52) U.S. Cl. CPC E06B 9/44; E06B 2009/445

(57) ABSTRACT

A cordless round-tube roller shade and a production process thereof are provided. The cordless round-tube roller shade includes a roller shade and a pair of fixing hooks for hanging the roller shade, where the roller shade includes a plurality of round tubes that are arranged horizontally in sequence from top to bottom; the plurality of round tubes are woven through a plurality of vertical weaving yarns; an upper end and a lower end of the roller shade each are provided with a roller shade rail; a pair of hook clasps matching with the pair of fixing hooks are slidably disposed on the roller shade rail at the upper end; and the cordless round-tube roller shade further includes a pair of double-ended hooks.

### CROSS-REFERENCE TO THE RELATED APPLICATIONS

This application is the national phase entry of International Application No. PCT/CN2024/143101, filed on Dec. 27, 2024, which is based upon and claims priority to Chinese Patent Application No. 202410373327.7, filed on Mar. 29, 2024, the entire contents of which are incorporated herein by reference.

### TECHNICAL FIELD

The present disclosure relates to the technical field of roller shades, and in particular to a cordless round-tube roller shade and a production process thereof.

### BACKGROUND

Roller shades are common assemblies for decoration. Due to modern decoration concepts, higher requirements are imposed on materials, strength and safety of the roller shades. Roller shades are required to have corresponding structural strengths and reasonable functions depending on their different mounted positions, heights, widths and weather conditions. Existing roller shades are easily bent when the strength is insufficient, are prone to damage, and have safety issues of cord entanglement of children when using cord-operated rolling methods.

### SUMMARY

In view of the above-mentioned problems, the present disclosure provides a cordless round-tube roller shade. Without the safety issue of cord entanglement to children, the roller shade has the low cost, high structural strength, ease of cutting and assembly, and strong universality.

To solve the above technical problem, the technical solutions adopted by the present disclosure are as follows.

A cordless round-tube roller shade includes a roller shade and a pair of fixing hooks for hanging the roller shade, where the roller shade includes a plurality of round tubes that are arranged horizontally in sequence from top to bottom; the plurality of round tubes are woven through a plurality of vertical weaving yarns; an upper end and a lower end of the roller shade each are provided with a roller shade rail; and a pair of hook clasps matching with the pair of fixing hooks are slidably disposed on the roller shade rail at the upper end; and
the cordless round-tube roller shade further includes a pair of double-ended hooks; and in response to a rolled state of the roller shade, two ends of each of the double-ended hooks are respectively hung into a gap between a weaving yarn and a round tube at a rolled side of the roller shade and a gap between a weaving yarn and a round tube at a vertical side of the roller shade.

Preferably, the roller shade rail includes a docking channel and a sliding channel; a plurality of round tubes at each of the upper end and the lower end of the roller shade are folded and then put into the docking channel; a limiting port configured to allow the roller shade to pass through and clamped between adjacent round tubes is formed at a bottom of the docking channel; and a strip-shaped port is formed at a top of the sliding channel.

Preferably, the hook clasp includes a sliding seat and a hanging hole; the sliding seat is disposed in the sliding channel; the strip-shaped port is configured to allow the hanging hole to pass through; and the fixing hook is configured to hook the hanging hole.

Preferably, the round tubes are made of a polypropylene (PP) material, the roller shade rail is made of a polyvinyl chloride (PVC) material, the hook clasp is made of an acrylonitrile butadiene styrene (ABS) material, the weaving yarns are made of a polyester material, the fixing hook is made of a ferrous material, and the double-ended hook is made of a nylon material.

The present disclosure further provides a production process of the cordless round-tube roller shade, including the following specific steps:
S1: extruding the round tubes and the roller shade rail through an extrusion mold, and cooling the round tubes and the roller shade rail through a forming mold;
S2: injection-molding the double-ended hook and the hook clasp through an injection mold;
S3: producing the fixing hook by thread tapping and sheet metal machining, and producing the weaving yarns by drawing, blending and twisting;
S4: weaving the round tubes into a whole at an equally-divided size with the weaving yarns through a weaving machine, cutting a width and a drop of the roller shade through a cutting and folding device, and folding and bonding the round tubes at each of the upper end and the lower end of the roller shade; and
S5: putting a folded position at each of the upper end and the lower end of the roller shade into the docking channel of the roller shade rail, thereby completing an assembly process before delivery, where
the cutting and folding device includes a cutting table; a roller shade groove configured to place the roller shade is formed at a top of the cutting table; a horizontal bracket and a vertical bracket are fixedly disposed above the cutting table; a pair of drop edge pressing plates capable of moving toward each other are respectively disposed at two ends of the horizontal bracket; a pair of width edge pressing plates capable of moving toward each other are respectively disposed at two ends of the vertical bracket; a cutting knife capable of moving down for cutting is disposed in each of the pair of drop edge pressing plates and the pair of width edge pressing plates; a mounting groove is formed at a bottom of each of the pair of width edge pressing plates; a gluing tube and a quick-drying air duct that are capable of moving horizontally are disposed in the mounting groove; a pair of moving plates capable of moving toward each other are further disposed in the mounting groove; opposite sidewalls of the pair of moving plates each are provided with a pair of fixing insertion rods and a pair of rotating insertion rods capable of rotating; and the fixing insertion rods and the rotating insertion rods can be inserted into end holes of corresponding round tubes.

Preferably, a mounting port is formed in each of the horizontal bracket and the vertical bracket; a double-ended threaded rod is rotatably connected in the mounting port; a motor capable of driving the double-ended threaded rod to rotate is disposed at an end of each of the horizontal bracket and the vertical bracket; two ends of the double-ended threaded rod each are threadedly connected to a slider; a bottom of the slider is fixedly connected to a mounting arm; pneumatic cylinders are respectively disposed at two ends of the mounting arm; and the drop edge pressing plate and the width edge pressing plate are respectively fixedly disposed at telescoping ends of corresponding pneumatic cylinders.

Preferably, a knife groove is formed at a bottom of each of the drop edge pressing plate and the width edge pressing plate; the cutting knife is located in a corresponding knife groove; a pair of hydraulic cylinders are fixedly disposed at a top of each of the drop edge pressing plate and the width edge pressing plate; and telescoping ends of the hydraulic cylinders extend to a corresponding knife groove and are fixedly connected to a corresponding cutting knife.

Preferably, an electric slide rail is fixedly disposed in the mounting groove; a sliding plate is slidably disposed on the electric slide rail; and both the gluing tube and the quick-drying air duct are disposed at a bottom of the sliding plate.

Preferably, a double-ended pneumatic cylinder is fixedly disposed in the mounting groove; two telescoping ends of the double-ended pneumatic cylinder each are fixedly connected to a connecting arm; a tail end of the connecting arm is fixedly connected to a corresponding moving plate; and a bottom of the moving plate extends out of the mounting groove.

Preferably, a mounting cavity is formed in the moving plate; a rotating shaft is rotatably connected in the mounting cavity; a gear is fixed on the rotating shaft; an electric telescoping rod is fixedly disposed in the mounting cavity; a toothed plate engaged with the gear is fixed at a telescoping end of the electric telescoping rod; a tail end of the rotating shaft extends out of the mounting cavity and is fixedly connected to a rotating arm; and the pair of rotating insertion rods are fixed on a sidewall of the rotating arm.

The present disclosure has the following beneficial effects:
1. The roller shade is arranged by a plurality of round tubes and woven by weaving yarns, with a simple structure, a high structural strength and ease of production. Two ends of the roller shade each are provided with the roller shade rail, preventing damage to the two ends. A pair of hook clasps are directly inserted into the roller shade rail, with an adjustable spacing. The whole roller shade can be hung with the hooks, such that the assembly is easy.
2. After rolled, the roller shade is hung with a pair of double-ended hooks at a large adjustable height. With the cordless rolling method, the roller shade can mitigate the safety issue easily caused by the corded roller shade, and has a high aesthetic degree after rolled, meeting aesthetic requirements of modern consumers.
3. The round tubes are made of the PP material. The roller shade trail is made of the PVC material. The hook clasp is made of the ABS material. The weaving yarns are made of the polyester material. The fixing hook is made of the ferrous material. The double-ended hook is made of the nylon material. The round tubes and the roller shade rail are extruded through the extrusion mold, and cooled through the forming mold. The double-ended hook and the hook clasp are injection-molded through the injection mold. The fixing hook is produced by thread tapping and sheet metal machining, and the weaving yarns are produced by drawing, blending and twisting. All materials are highly lightweight, the structural strength is high, and the production process is simple, which can realize batch production.
4. The whole roller shade is cut by the cutting and folding device. The width and the drop can be automatically cut. The round tubes at each of the upper end and the lower end of the roller shade are folded and bonded. Through a pair of drop edge pressing plates, a pair of width edge pressing plates, and cutting knives, the cutting position can be adjusted according to customer requirements. During cutting, a drop edge and a width edge of the roller shade are pressed. Driven by the hydraulic cylinders, the cutting knife moves down, thereby cutting the roller shade of the corresponding size.
5. With the gluing tube, the quick-drying air duct and the electric slide rail, before the drop is cut, glue is applied onto the two ends of the roller shade through the gluing tube, and the glue is quickly cured by gas blown from the quick-drying air duct, such that the weaving yarn and the round tube at the cutting position are bonded, preventing dispersion upon the cutting. The folding plane can further be glued by the gluing tube before folding, such that the folded round tube is bonded firmly, and clamped into the roller shade rail.
6. With one pair of moving plates, two pairs of fixing insertion rods and two pairs of rotating insertion rods, before the folding, one pair of moving plates move toward each other through the double-ended pneumatic cylinder, such that the two pairs of fixing insertion rods and the two pairs of rotating insertion rods are respectively inserted into end holes at two ends of corresponding round tubes. The rotating arm drives one pair of rotating insertion rods to rotate, such that two round tubes can be folded and bonded.

### BRIEF DESCRIPTION OF THE DRAWINGS

FIG. 1 is a schematic structural view according to the present disclosure;

FIG. 2 is a schematic view of a rolled state according to the present disclosure;

FIG. 3 is a schematic enlarged view of a structure at A shown in FIG. 2;

FIG. 4 is a schematic enlarged view of a structure at B shown in FIG. 2;

FIG. 5 is a schematic enlarged view of a structure at C shown in FIG. 2;

FIG. 6 is a schematic structural view of a roller shade rail according to the present disclosure;

FIG. 7 is a schematic structural view of a hook clasp according to the present disclosure;

FIG. 8 is a schematic structural view of a fixing hook according to the present disclosure;

FIG. 9 is a schematic structural view of a double-ended hook according to the present disclosure;

FIG. 10 is a top view of a cutting and folding device according to the present disclosure;

FIG. 11 is a bottom view of a width edge pressing plate according to the present disclosure;

FIG. 12 is a sectional view of a moving plate according to the present disclosure;

FIG. 13 is a schematic view of a cutting position and a gluing position according to the present disclosure; and

FIG. 14 is a schematic view of a folded state of a roller shade according to the present disclosure.

In the figures: 1: roller shade, 2: roller shade rail, 201: docking channel, 202: sliding channel, 203: strip-shaped port, 204: limiting port, 3: weaving yarn, 4: hook clasp, 401: sliding seat, 402: hanging hole, 5: fixing hook, 6: double-ended hook, 7: round tube, 8: cutting table, 9: roller shade groove, 10: drop edge pressing plate, 11: width edge pressing plate, 12: mounting arm, 13: pneumatic cylinder, 14: hydraulic cylinder, 15: horizontal bracket, 16: vertical bracket, 17: double-ended threaded rod, 18: slider, 19: motor, 20: knife groove, 21: cutting knife, 22: electric slide rail, 23: sliding plate, 24: quick-drying air duct, 25: gluing tube, 26: moving plate, 27: connecting arm, 28: double-ended pneumatic cylinder, 29: mounting groove, 30: fixing insertion rod, 31: rotating insertion rod, 32: rotating arm, 33: rotating shaft, 34: gear, 35: mounting cavity, 36: toothed plate, 37: electric telescoping rod, 38: cutting position, 39: gluing position, 40: folding plane, and 41: bonding plane.

### DETAILED DESCRIPTION OF THE EMBODIMENTS

To make the foregoing objectives, features, and advantages of the present disclosure clearer and more comprehensible, the specific implementations of the present disclosure are described in detail below with reference to the drawings. The following describes many details in order to provide a thorough understanding of the present disclosure. However, the present disclosure can be implemented in many other ways other than those described herein, and those skilled in the art can make similar improvements without departing from the connotation of the present disclosure, and thus the present disclosure is not limited to the specific implementations disclosed below.

It should be noted that, when a component is fixed to another component, the component may be fixed to the other component directly or via an intermediate component. When a component is connected to another component, the component may be connected to the another component directly or via an intermediate component. The terms “vertical”, “horizontal”, “left”, “right”, and similar terms used herein are just for illustrative purposes, and do not mean sole implementations.

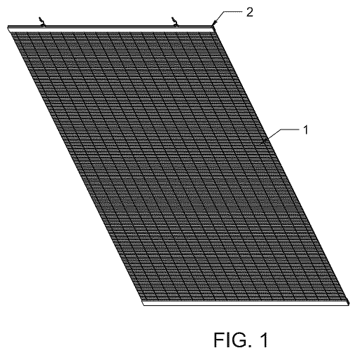

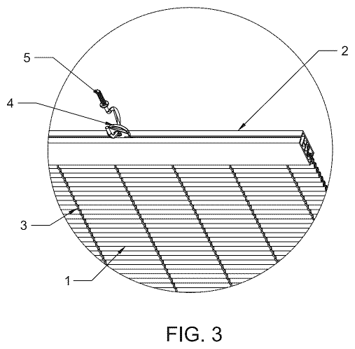

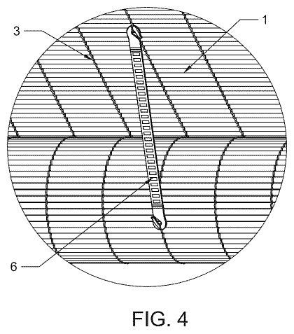

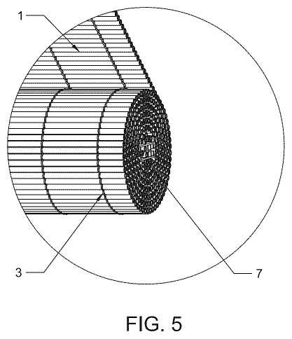

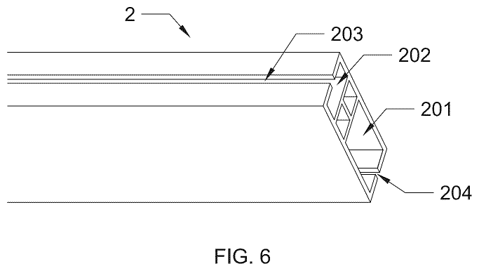

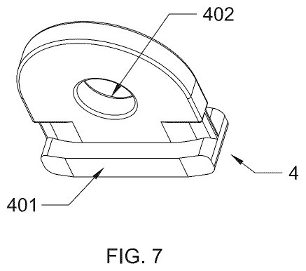

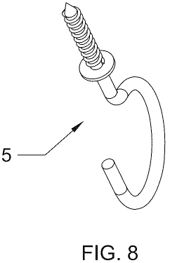

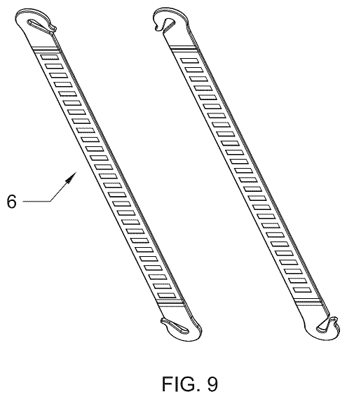

Referring to FIGS. 1-9, a cordless round-tube roller shade includes roller shade 1 and a pair of fixing hooks 5 for hanging the roller shade 1. The roller shade 1 includes a plurality of round tubes 7 that are arranged horizontally in sequence from top to bottom. The plurality of round tubes 7 are woven through a plurality of vertical weaving yarns 3. An upper end and a lower end of the roller shade 1 each are provided with roller shade rail 2. A pair of hook clasps 4 matching with the pair of fixing hooks 5 are slidably disposed on the roller shade rail 2 at the upper end.

The cordless round-tube roller shade further includes a pair of double-ended hooks 6. In response to a rolled state of the roller shade 1, two ends of each of the double-ended hooks 6 are respectively hung into a gap between weaving yarn 3 and round tube 7 at a rolled side of the roller shade 1 and a gap between weaving yarn 3 and round tube 7 at a vertical side of the roller shade 1.

Further, the roller shade rail 2 includes docking channel 201 and sliding channel 202. A plurality of round tubes 7 at each of the upper end and the lower end of the roller shade 1 are folded and then put into the docking channel 201. Limiting port 204 configured to allow the roller shade 1 to pass through and clamped between adjacent round tubes 7 is formed at a bottom of the docking channel 201. Strip-shaped port 203 is formed at a top of the sliding channel 202. The hook clasp 4 includes sliding seat 401 and hanging hole 402. The sliding seat 401 is disposed in the sliding channel 202. The strip-shaped port 203 is configured to allow the hanging hole 402 to pass through. The fixing hook 5 is configured to hook the hanging hole 402.

Further, the roller tubes 7 are made of a PP material, the roller shade rail 2 is made of a PVC material, the hook clasp 4 is made of an ABS material, the weaving yarns 3 are made of a polyester material, the fixing hook 5 is made of a ferrous material, and the double-ended hook 6 is made of a nylon material. All materials have a high lightweight degree and a high structural strength.

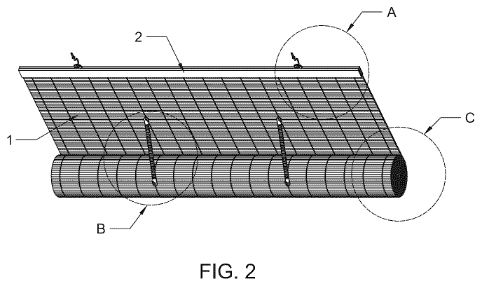

In assembly, sliding seats 401 of two hook clasps 4 are put into the sliding channel 202 of the roller shade rail 2, and can be slid freely left and right. The pair of fixing hooks 5 are fixed by the user to a top of a to-be-isolated region according to a corresponding size. Hanging holes 402 of the hook clasps 4 are hung onto the fixing hooks 5, thereby completing a hanging process. During rolling from the bottom up, the two ends of the double-ended hook 6 are respectively hung into the gap between the weaving yarn 3 and the round tube 7 at the rolled side of the roller shade 1 and the gap between the weaving yarn 3 and the round tube 7 at the vertical side of the roller shade 1, which is shown in FIG. 2, and convenient in use.

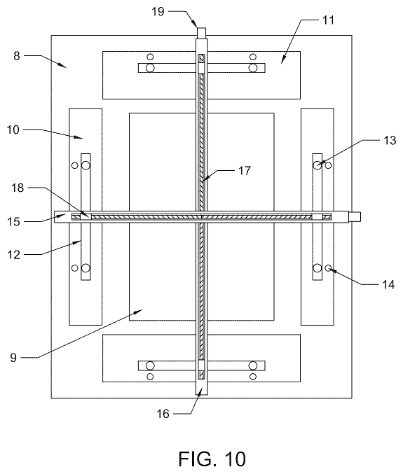

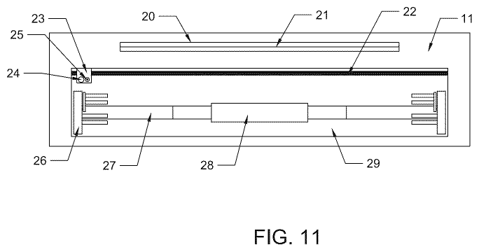

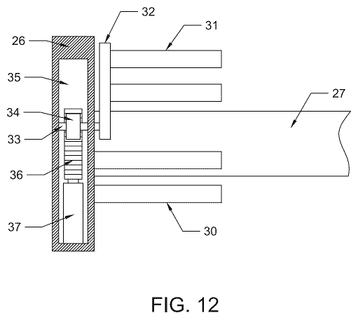

Referring to FIGS. 10-14, a production process of the cordless round-tube roller shade includes the following specific steps:
S1: The round tubes 7 and the roller shade rail 2 are extruded through an extrusion mold and cooled through a forming mold.
S2: The double-ended hook 6 and the hook clasp 4 are injection-molded through an injection mold.
S3: The fixing hook 5 is produced by thread tapping and sheet metal machining, and the weaving yarns 3 are produced by drawing, blending and twisting.
S4: The round tubes 7 are woven into a whole at an equally-divided size with the weaving yarns 3 through a weaving machine. A width and a drop of the whole roller shade 1 are cut by a cutting and folding device. The round tubes 7 at each of the upper end and the lower end of the roller shade 1 are folded and bonded.
S5: A folded position at each of the upper end and the lower end of the roller shade 1 is put into the docking channel 201 of the roller shade rail 2, thereby completing an assembly process before delivery.

The cutting and folding device includes cutting table 8. Roller shade groove 9 configured to place the whole roller shade 1 is formed at a top of the cutting table 8. Horizontal bracket 15 and vertical bracket 16 are fixedly disposed above the cutting table 8. A pair of drop edge pressing plates 10 capable of moving toward each other are respectively disposed at two ends of the horizontal bracket 15. A pair of width edge pressing plates 11 capable of moving toward each other are respectively disposed at two ends of the vertical bracket 16. A mounting port is formed in each of the horizontal bracket 15 and the vertical bracket 16. Double-ended threaded rod 17 is rotatably connected in the mounting port. Motor 19 capable of driving the double-ended threaded rod 17 to rotate is disposed at an end of each of the horizontal bracket 15 and the vertical bracket 16. Two ends of the double-ended threaded rod 17 each are threadedly connected to slider 18. A bottom of the slider 18 is fixedly connected to mounting arm 12. Pneumatic cylinders 13 are respectively disposed at two ends of the mounting arm 12. The drop edge pressing plate 10 and the width edge pressing plate 11 are respectively fixedly disposed at telescoping ends of corresponding pneumatic cylinders 13. A cutting position can be adjusted according to customer requirements, thereby cutting the roller shade of a corresponding size.

Cutting knife 21 capable of moving down for cutting is disposed in each of the pair of drop edge pressing plates 10 and the pair of width edge pressing plates 11. Knife groove 20 is formed at a bottom of each of the drop edge pressing plate 10 and the width edge pressing plate 11. The cutting knife 21 is located in corresponding knife groove 20. A pair of hydraulic cylinders 14 are fixedly disposed at a top of each of the drop edge pressing plate 10 and the width edge pressing plate 11. Telescoping ends of the hydraulic cylinders 14 extend to corresponding knife groove 20 and are fixedly connected to corresponding cutting knife 21. By starting the pair of hydraulic cylinders 14, the cutting knife 21 can be driven to move down, thereby cutting a drop edge and a width edge.

Mounting groove 29 is formed at a bottom of each of the pair of width edge pressing plates 11. Gluing tube 25 and quick-drying air duct 24 that are capable of moving horizontally are disposed in the mounting groove 29. Electric slide rail 22 is fixedly disposed in the mounting groove 29. Sliding plate 23 is slidably disposed on the electric slide rail 22. Both the gluing tube 25 and the quick-drying air duct 24 are disposed at a bottom of the sliding plate 23. Through the electric slide rail 22 and the sliding plate 23, the gluing tube 25 is driven to move horizontally. Glue extruded from the gluing tube 25 uniformly falls onto a top of corresponding round tube 7. The glue flows to gaps at two sides of the round tube 7 along a tube wall. By starting the quick-drying air duct 24 to blow a gas, the glue is cured quickly, thereby bonding weaving yarn 3 at cutting position 38 to the tube wall of the round tube 7, and preventing dispersion upon cutting.

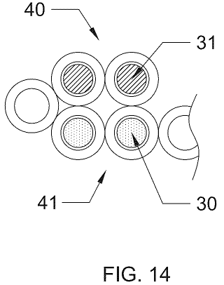

A pair of moving plates 26 capable of moving toward each other are further disposed in the mounting groove 29. Opposite sidewalls of the pair of moving plates 26 each are provided with a pair of fixing insertion rods 30 and a pair of rotating insertion rods 31 capable of rotating. The fixing insertion rods 30 and the rotating insertion rods 31 can be inserted into end holes of corresponding round tubes 7. Double-ended pneumatic cylinder 28 is fixedly disposed in the mounting groove 29. Two telescoping ends of the double-ended pneumatic cylinder 28 each are fixedly connected to connecting arm 27. A tail end of the connecting arm 27 is fixedly connected to corresponding moving plate 26. A bottom of the moving plate 26 extends out of the mounting groove 29. Mounting cavity 35 is formed in the moving plate 26. Rotating shaft 33 is rotatably connected in the mounting cavity 35. Gear 34 is fixed on the rotating shaft 33. Electric telescoping rod 37 is fixedly disposed in the mounting cavity 35. Toothed plate 36 engaged with the gear 34 is fixed at a telescoping end of the electric telescoping rod 37. A tail end of the rotating shaft 33 extends out of the mounting cavity 35 and is fixedly connected to rotating arm 32. The pair of rotating insertion rods 31 are fixed on a sidewall of the rotating arm 32. By starting the electric telescoping rod 37, the toothed plate 36 is driven to move. The rotating shaft 33 is then driven by the gear 34 to rotate. Thereafter, the rotating arm 32 drives the pair of rotating insertion rods 31 to rotate, thereby driving two round tubes 7 on folding plane 40 to fold to a state shown in FIG. 14, and completing a bonding process.

The whole woven roller shade 1 is put into the roller shade groove 9. The end holes of the round tubes 7 are higher than the roller shade groove 9. The motor 19 on the horizontal bracket 15 is started, thereby driving corresponding double-ended threaded rod 17 to rotate. Through a pair of sliders 18, a pair of mounting arms 12 are driven to move toward each other. A spacing between two cutting knives 21 is a width to be cut. A pair of pneumatic cylinders 13 are started, thereby driving the drop edge pressing plate 10 to move down to press a plurality of round tubes 7 at the drop edge. Then, a pair of hydraulic cylinder 14 are started, thereby driving the cutting knife 21 to move down to cut the plurality of round tubes 7 at the same time.

After the width is cut, the drop is cut. By only starting the motor 19 on the vertical bracket 16, a pair of width edge pressing plates 11 are driven to move toward each other, such that the gluing tube 25 moves to gluing position 39 close to the cutting position 38. Through the electric slide rail 22 and the sliding plate 23, the gluing tube 25 is driven to move horizontally. Glue extruded from the gluing tube 25 uniformly falls onto a top of corresponding round tube 7. The glue flows to gaps at two sides of the round tube 7 along a tube wall. By starting the quick-drying air duct 24 to blow a gas, the glue is cured quickly, thereby bonding weaving yarn 3 at cutting position 38 to the tube wall of the round tube 7. Thereafter, the cutting knife 21 is moved to the cutting position 38. The width edge-pressing plate 11 between the knife groove 20 and the mounting groove 29 can press the round tubes 7 at the cutting position 38. The cutting knife 21 is moved down, thereby trimming the drop.

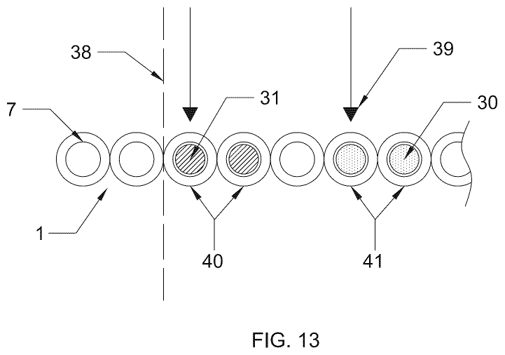

After the drop is cut, the gluing tube 25 is moved to gluing position 39 away from the cutting position 38. Glue is applied onto surfaces of round tubes 7 on bonding plane 41. Then, a pair of moving plates 26 are pulled through the double-ended pneumatic cylinder 28 and the connecting arm 27 to move toward each other, such that two pairs of fixing insertion rods 30 and two pairs of rotating insertion rods 31 are inserted into end holes at two ends of round tubes 7 at a corresponding position, as shown in FIG. 13. By starting the electric telescoping rod 37, the toothed plate 36 is driven to move. Through the gear 34, the rotating shaft 33 is driven to rotate. Then, the rotating arm 32 drives a pair of rotating rods 31 to rotate, thereby driving two round tubes 7 on the folding plane 40 to fold to the state shown in FIG. 14, thereby completing the bonding process.

The above are merely preferred examples of the present disclosure, and are not intended to limit the present disclosure. Any modifications, equivalent replacements, improvements, and the like made within the spirit and principle of the present disclosure shall be all included in the protection scope of the present disclosure.

What is claimed is:

1. A cordless round-tube roller shade, comprising: a roller shade and a pair of fixing hooks for hanging the roller shade, wherein the roller shade comprises a plurality of round tubes that are arranged horizontally in sequence from top to bottom; the plurality of round tubes are woven through a plurality of vertical weaving yarns; an upper end and a lower end of the roller shade each are provided with a roller shade rail; and a pair of hook clasps matching with the pair of fixing hooks are slidably disposed on the roller shade rail at the upper end; and
the cordless round-tube roller shade further comprises a pair of double-ended hooks; and in response to a rolled state of the roller shade two ends of each of the pair of double-ended hooks are respectively hung into a gap between a weaving yarn and a round tube at a rolled side of the roller shade and a gap between a weaving yarn and a round tube at a vertical side of the roller shade.

2. The cordless round-tube roller shade according to claim 1, wherein the roller shade rail comprises a docking channel and a sliding channel; a plurality of round tubes at each of the upper end and the lower end of the roller shade are folded and then put into the docking channel; a limiting port configured to allow the roller shade to pass through and clamped between adjacent round tubes is formed at a bottom of the docking channel; and a strip-shaped port is formed at a top of the sliding channel.

3. The cordless round-tube roller shade according to claim 2, wherein the hook clasp comprises a sliding seat and a hanging hole; the sliding seat is disposed in the sliding channel; the strip-shaped port is configured to allow the hanging hole to pass through; and the fixing hook is configured to hook the hanging hole.

4. The cordless round-tube roller shade according to claim 1, wherein the plurality of round tubes are made of a polypropylene (PP) material, the roller shade rail) is made of a polyvinyl chloride (PVC) material, the hook clasp is made of an acrylonitrile butadiene styrene (ABS) material, the plurality of vertical weaving yarns are made of a polyester material, the fixing hook is made of a ferrous material, and the double-ended hook is made of a nylon material.

5. A production process of the cordless round-tube roller shade according to claim 1, comprising the following steps:
S1: extruding the plurality of round tubes and the roller shade rail through an extrusion mold, and cooling the plurality of round tubes and the roller shade rail through a forming mold;
S2: injection-molding the double-ended hook and the hook clasp through an injection mold;
S3: producing the fixing hook by thread tapping and sheet metal machining, and producing the plurality of vertical weaving yarns by drawing, blending and twisting;
S4: weaving the plurality of round tubes into a whole at an equally-divided size with the plurality of vertical weaving yarns through a weaving machine, cutting a width and a drop of the roller shade through a cutting and folding device, and folding and bonding the plurality of round tubes at each of the upper end and the lower end of the roller shade; and
S5: putting a folded position at each of the upper end and the lower end of the roller shade into a docking channel of the roller shade rail, wherein an assembly process before delivery is completed, wherein
the cutting and folding device comprises a cutting table; a roller shade groove configured to place the roller shade is formed at a top of the cutting table a horizontal bracket and a vertical bracket are fixedly disposed above the cutting table; a pair of drop edge pressing plates configured for moving toward each other are respectively disposed at two ends of the horizontal bracket; a pair of width edge pressing plates configured for moving toward each other are respectively disposed at two ends of the vertical bracket; a cutting knife configured for moving down for cutting is disposed in each of the pair of drop edge pressing plates and the pair of width edge pressing plates; a mounting groove is formed at a bottom of each of the pair of width edge pressing plates; a gluing tube and a quick-drying air duct that are configured for moving horizontally are disposed in the mounting groove; a pair of moving plates configured for moving toward each other are further disposed in the mounting groove opposite sidewalls of the pair of moving plates each are provided with a pair of fixing insertion rods and a pair of rotating insertion rods and the fixing insertion rods and the rotating insertion rods are configured for being inserted into end holes of corresponding round tubes.

6. The production process of the cordless round-tube roller shade according to claim 5, wherein a mounting port is formed in each of the horizontal bracket and the vertical bracket; a double-ended threaded rod is rotatably connected in the mounting port; a motor configured for driving the double-ended threaded rod-to rotate is disposed at an end of each of the horizontal bracket and the vertical bracket; two ends of the double-ended threaded rod each are threadedly connected to a slider; a bottom of the slider) is fixedly connected to a mounting arm; pneumatic cylinders are respectively disposed at two ends of the mounting arm; and the drop edge pressing plate and the width edge pressing plate are respectively fixedly disposed at telescoping ends of corresponding pneumatic cylinders.

7. The production process of the cordless round-tube roller shade according to claim 5, wherein a knife groove is formed at a bottom of each of the drop edge pressing plate and the width edge pressing plate; the cutting knife is located in a corresponding knife groove; a pair of hydraulic cylinders are fixedly disposed at a top of each of the drop edge pressing plate and the width edge pressing plate; and telescoping ends of the pair of hydraulic cylinders extend to a corresponding knife groove and are fixedly connected to a corresponding cutting knife.

8. The production process of the cordless round-tube roller shade according to claim 5, wherein an electric slide rail is fixedly disposed in the mounting groove; a sliding plate is slidably disposed on the electric slide rail; and both the gluing tube and the quick-drying air duct are disposed at a bottom of the sliding plate.

9. The production process of the cordless round-tube roller shade according to claim 5, wherein a double-ended pneumatic cylinder is fixedly disposed in the mounting groove; two telescoping ends of the double-ended pneumatic cylinder each are fixedly connected to a connecting arm; a tail end of the connecting arm is fixedly connected to a corresponding moving plate; and a bottom of the moving plate extends out of the mounting groove

10. The production process of the cordless round-tube roller shade according to claim 5, wherein a mounting cavity is formed in the moving plate; a rotating shaft is rotatably connected in the mounting cavity a gear is fixed on the rotating shaft an electric telescoping rod is fixedly disposed in the mounting cavity; a toothed plate engaged with the gear is fixed at a telescoping end of the electric telescoping rod a tail end of the rotating shaft extends out of the mounting cavity and is fixedly connected to a rotating arm; and the pair of rotating insertion rods are fixed on a sidewall of the rotating arm.

11. The production process according to claim 5, wherein in the cordless round-tube roller shade, the roller shade rail comprises the docking channel and a sliding channel; a plurality of round tubes at each of the upper end and the lower end of the roller shade are folded and then put into the docking channel; a limiting port configured to allow the roller shade to pass through and clamped between adjacent round tubes is formed at a bottom of the docking channel; and a strip-shaped port is formed at a top of the sliding channel.

12. The production process according to claim 11, wherein in the cordless round-tube roller shade, the hook clasp comprises a sliding seat and a hanging hole; the sliding seat is disposed in the sliding channel; the strip-shaped port is configured to allow the hanging hole to pass through; and the fixing hook is configured to hook the hanging hole.

13. The production process according to claim 5, wherein in the cordless round-tube roller shade, the plurality of round tubes are made of a polypropylene (PP) material, the roller shade rail is made of a polyvinyl chloride (PVC) material, the hook clasp is made of an acrylonitrile butadiene styrene (ABS) material, the plurality of vertical weaving yarns are made of a polyester material, the fixing hook is made of a ferrous material, and the double-ended hook is made of a nylon material.

14. The production process of the cordless round-tube roller shade according to claim 11, wherein a mounting port is formed in each of the horizontal bracket and the vertical bracket; a double-ended threaded rod is rotatably connected in the mounting port; a motor configured for driving the double-ended threaded rod to rotate is disposed at an end of each of the horizontal bracket and the vertical bracket; two ends of the double-ended threaded rod each are threadedly connected to a slider; a bottom of the slider is fixedly connected to a mounting arm; pneumatic cylinders are respectively disposed at two ends of the mounting arm; and the drop edge pressing plate and the width edge pressing plate are respectively fixedly disposed at telescoping ends of corresponding pneumatic cylinders.

15. The production process of the cordless round-tube roller shade according to claim 12, wherein a mounting port is formed in each of the horizontal bracket and the vertical bracket; a double-ended threaded rod is rotatably connected in the mounting port; a motor configured for driving the double-ended threaded rod to rotate is disposed at an end of each of the horizontal bracket and the vertical bracket; two ends of the double-ended threaded rod each are threadedly connected to a slider; a bottom of the slider is fixedly connected to a mounting arm; pneumatic cylinders are respectively disposed at two ends of the mounting arm; and the drop edge pressing plate and the width edge pressing plate are respectively fixedly disposed at telescoping ends of corresponding pneumatic cylinders.

16. The production process of the cordless round-tube roller shade according to claim 13, wherein a mounting port is formed in each of the horizontal bracket and the vertical bracket; a double-ended threaded rod is rotatably connected in the mounting port; a motor configured for driving the double-ended threaded rod to rotate is disposed at an end of each of the horizontal bracket and the vertical bracket; two ends of the double-ended threaded rod each are threadedly connected to a slider; a bottom of the slider is fixedly connected to a mounting arm; pneumatic cylinders are respectively disposed at two ends of the mounting arm; and the drop edge pressing plate and the width edge pressing plate are respectively fixedly disposed at telescoping ends of corresponding pneumatic cylinders.

17. The production process of the cordless round-tube roller shade according to claim 11, wherein a knife groove is formed at a bottom of each of the drop edge pressing plate and the width edge pressing plate; the cutting knife is located in a corresponding knife groove; a pair of hydraulic cylinders are fixedly disposed at a top of each of the drop edge pressing plate and the width edge pressing plate; and telescoping ends of the pair of hydraulic cylinders extend to a corresponding knife groove and are fixedly connected to a corresponding cutting knife.

18. The production process of the cordless round-tube roller shade according to claim 12, wherein a knife groove is formed at a bottom of each of the drop edge pressing plate and the width edge pressing plate; the cutting knife is located in a corresponding knife groove; a pair of hydraulic cylinders are fixedly disposed at a top of each of the drop edge pressing plate and the width edge pressing plate; and telescoping ends of the pair of hydraulic cylinders extend to a corresponding knife groove and are fixedly connected to a corresponding cutting knife.

19. The production process of the cordless round-tube roller shade according to claim 13, wherein a knife groove is formed at a bottom of each of the drop edge pressing plate and the width edge pressing plate; the cutting knife is located in a corresponding knife groove; a pair of hydraulic cylinders are fixedly disposed at a top of each of the drop edge pressing plate and the width edge pressing plate; and telescoping ends of the pair of hydraulic cylinders extend to a corresponding knife groove and are fixedly connected to a corresponding cutting knife.

20. The production process of the cordless round-tube roller shade according to claim 11, wherein an electric slide rail is fixedly disposed in the mounting groove; a sliding plate is slidably disposed on the electric slide rail; and both the gluing tube and the quick-drying air duct are disposed at a bottom of the sliding plate.
